(19) United States
(12) Patent Application Publication
(10) Pub. No.: US 2007/0165191 A1
(43) Pub. Date: Jul. 19, 2007

(54) Projection type image-displaying apparatus and projection type image-displaying system

(75) Inventor: Kunikatsu Shimada, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/490,113

(22) Filed: Jul. 21, 2006

(30) Foreign Application Priority Data
Jan. 19, 2006 (JP) 2006-011608

(51) Int. Cl. G03B 21/14

(52) U.S. Cl. 353/70; 353/79

(57) ABSTRACT

A projector apparatus (10) is used in which an optical portion (100) is offset so that an image light projected on a projection surface (20A) becomes suitable for a screen (20) provided in an inclined form, whereby an image free from any of strains can be simply projected on the screen (20) provided simply on a desk or the like. In addition, since the projection surface (20A) is constructed so as to have a screen gain, satisfactory visibility is obtained even with a projector apparatus having a smaller luminance than that of a large projector apparatus.

The present application is based on Japanese patent application No. 2006-011608, the entire contents of which are incorporated herein by reference.

### BACKGROUND

1. Field

One embodiment of the present invention relates to a projection type image-displaying apparatus and a projection type image-displaying system, and more particularly to a projection type image-displaying apparatus and a projection type image-displaying system in each of which installation and adjustment for an apparatus provided therein can be simplified, and an efficient operation can be made even with small scale projection.

2. Description of the Related Art

In recent years, the needs for desiring to more brightly and finely display an image on a large screen have increased, and the demand has rapidly risen for a projector, a consumer liquid crystal television, and the like. In addition, the digital broadcasting of high image quality also begins to become popular, and thus the needs for high image quality promotion and large screen promotion have increased year by year.

In addition, in recent years, the presentations and conferences using projection type image-displaying apparatuses (projectors) have also been actively carried out. The projection type image-displaying apparatuses have such features that the effective propaganda and information communication can be carried out by using an image light which is projected in the form of an image having a large size on a screen.

With regard to such applications, a front surface projection image-displaying system for projecting an image light emitted from a projecting portion on a screen is the mainstream. The front surface projection image-displaying system has such an advantage that no dead space occurs in the rear of the screen and the screen size has also a large degree of freedom depending on an ability of a projector because the image light is displayed on the screen to be reflected therefrom. On the other hand, since the projecting portion and the screen are provided independently of each other, the positioning becomes important in order to suitably project the image light. In particular, for the purpose of properly displaying an image, the adjustment must be performed such that the image light is made to strike at a right angle to the screen.

As for this sort of projection type image-displaying apparatus in which such adjustment is readily performed, a projection type image-displaying apparatus is known in which a distance between a projector and a screen is measured, and one of an angle of the projector and an image projected on the screen is automatically adjusted. This projection type image-displaying apparatus, for example, is disclosed in the Japanese Patent Kokai No. 2005-176226.

However, the projection type image-displaying apparatus disclosed in the Japanese Patent Kokai No. 2005-176226 involves such a problem that since the complicated control is required for the positioning of the apparatus or the projection state of the image light, a user is forced to carry out a complicated manipulation, and thus the convenienceness is reduced. In addition, the complicatedness in construction not only results in the scale up of the apparatus, but also becomes an obstacle to the cost down.

The front surface projection type projector has such a construction that the projecting portion and the screen are provided independently of each other, which results in that although an image is more readily obtained in a state of being projected on the large screen than an image is displayed on a monitor or the like, an adjustment work for obtaining a suitable image is indispensable. More specifically, there is required such positioning and adjustment that the image light is made to strike at a right angle to the screen. In addition, when the work for installing and adjusting the apparatus takes time, no efficient operation can be desired in a situation in which the projector is desired to be used in spite of a few viewers with no large scale projection as a prerequisite. For this reason, it is important to improve the convenienceness in user manipulation ranging from an apparatus installation stage to projection of the image light on the screen through the adjustment manipulation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are respectively an exemplary schematic constructional view of a projection type image-displaying system according to a first embodiment of the present invention, and an exemplary view showing a relationship between a screen and an optical system provided in the projection type image-displaying system shown in FIG. 1A;

FIG. 2 is an exemplary block diagram showing a schematic configuration of a main portion of a projector apparatus provided in the projection type image-displaying system according to the first embodiment of the present invention;

FIGS. 3A and 3B are respectively an exemplary front view of a screen provided in the projection type image-displaying system according to the first embodiment of the present invention, and an exemplary side elevational view of the screen shown in FIG. 3A;

FIG. 4 is an exemplary schematic constructional view showing a state of projection made by a conventional projector apparatus;

FIGS. 5A and 5B respectively an exemplary schematic constructional view of a projection type image-displaying system according to a second embodiment of the present invention, and an exemplary schematic constructional view of the projection type image-displaying system, shown in FIG. 5A, using an adapter for holding a posture of a projector apparatus provided in the projection-type image-displaying system of FIG. 5A;

FIG. 6 is an exemplary schematic constructional view of a projection type image-displaying system according to a third embodiment of the present invention; and

FIGS. 7A and 7B are respectively an exemplary front view showing another construction of a screen provided in a projection type image-displaying system according to a fourth embodiment of the present invention, and a n exemplary cross sectional view taken on a line A-A of FIG. 7A.

### DETAILED DESCRIPTION OF PREFERRED EMBODIMENTS

Various embodiments according to the invention will be described hereinafter with reference to the accompanying drawings. In general, according to one embodiment of the invention, there is provided a projection type image-displaying apparatus, including: a main body installed on an installation surface; and an optical portion, having an optical axis, for projecting an image light on an inclined projection surface, the optical portion being accommodated in the main body for the optical axis to be disposed relative to the installation surface by a predetermined angle determined in accordance with an inclination angle of the inclined projection surface.

In addition, according to one embodiment of the invention, there is provided a projection type image-displaying system, including: a projection type image-displaying apparatus including an optical portion, having an optical axis, for projecting an image light on an inclined projection surface, the optical axis being disposed so as to be parallel with a direction of a normal to the inclined projection surface; and a screen installed in a state in which the projection surface is inclined, the image light being projected on the inclined projection surface.

Also, according to one embodiment of the invention, there is provided a projection type image-displaying system, including: an optical portion for projecting an image light, the optical portion being accommodated in a main body, and at least one of the optical portion and the main body being inclined with respect to a reference plane by a predetermined angle; and a screen for receiving the image light to produce an image thereon, the screen being inclined with respect to the reference plane by an angle determined in accordance with the predetermined angle.

According to the present invention, the installation and adjustment of the apparatus in the projection type image-displaying system can be simplified, and the efficient operation can be made even with the small scale projection.

### First Embodiment

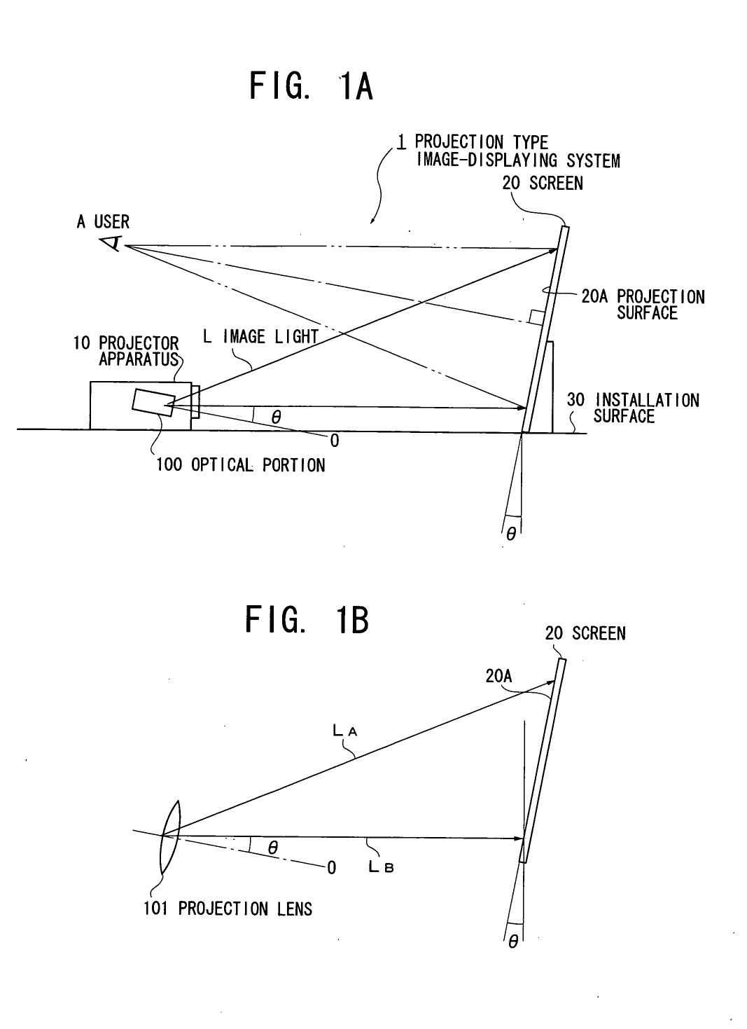

FIGS. 1A and 1B are respectively a schematic constructional view of a projection type image-displaying system 1 according to a first embodiment of the present invention, and a view showing a relationship between a screen and an optical system provided in the projection type image-displaying system 1 shown in FIG. 1A.

[Constructions of Portions]

The projection type image-displaying system 1, as shown in FIG. 1A, has a projector apparatus 10, as a front surface projection type image-displaying apparatus, for emitting an image light “L” based on an image such as a still image or a moving image, and a desk-top type screen 20 which is installed so as to be backward inclined at an angle θ of inclination with respect to a vertical direction. The projection type image-displaying system 1 is installed such that an optical portion 100 provided in the projector apparatus 10 makes the same angle θ as the angle θ of inclination in the screen 20 with respect to the horizontal direction.

The screen 20 includes a projection surface 20A having a screen gain representing sufficient brightness when a user A visually observes the image light “L” which is emitted from the projector apparatus 10 and is reflected by the projection surface 20A. In this embodiment, the projection type image-displaying system 1 is installed for its use such that a visual point of the user A is located upward with respect to the projector apparatus 10 as a prerequisite not to be interrupted by the projector apparatus 10.

FIG. 1B is a disposition view showing a relationship between a projection lens 101 of the optical portion 100, and the screen 20. The projection lens 101 is accommodated in a main body of the projector apparatus 10 so that a lower end L_{B} of the image light “L” becomes parallel with a surface of a desk or the like. An upper end L_{A} and the lower end L_{B} of the image light “L” are subjected to light distribution control so that the image light “L” has an offset amount of angle θ with respect to an optical axis “O” of the projection lens 101. The image light “L” subjected to the light distribution control is projected on the screen 20 which is backward inclined at the angle θ, whereby an optimal image is obtained which has a proper aspect ratio or the like on the projection surface 20A of the screen 20. Incidentally, in the first embodiment, the lower end L_{B} of the image light “L” does not need to be strictly parallel with the surface of the desk or the like, and thus may have such an angle (of about 3 to about 4 degrees) that the visibility is not impaired.

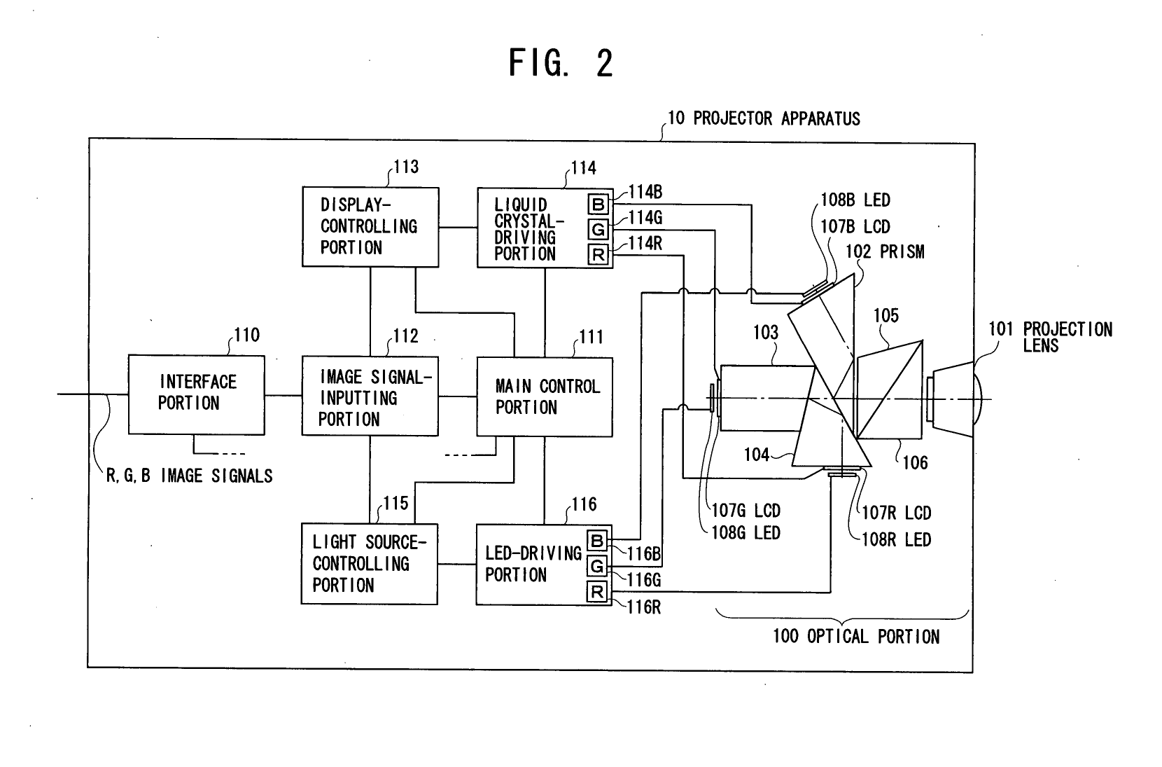

FIG. 2 is a block diagram showing a schematic configuration of a main portion of the projector apparatus 10 provided in the projection type image-displaying system 1 according to the first embodiment of the preset invention.

The projector apparatus 10 includes the optical portion 100 for emitting the image light, an interface portion 110 for receiving as its inputs RGB image signals from a digital versatile disk (DVD) player, a video deck, or a personal computer (PC) apparatus, a main control portion 111 for controlling the portions of the projector apparatus 10, and an image signal-inputting portion 112 for receiving as its inputs the RGB image signals inputted to the projector apparatus 10 through the interface portion 110. Also, the projector apparatus 10 includes a display-controlling portion 113 for outputting image signals based on an image corresponding to RGB colors in accordance with the image signal inputted from the image signal-inputting portion 112, a liquid crystal-driving portion 114 including driving circuits 114R, 114G and 114B for driving corresponding liquid crystal displays (LCDs) 107R, 107G and 107B, respectively, in accordance with the RGB image signals, a light source-controlling portion 115 for controlling light emission of light-emitting diodes (LEDs) as light sources in accordance with the image signals inputted from the image signal-inputting portion 112, and an LED-driving portion 116 including driving circuits 116R, 116G and 116B for driving corresponding LEDs 108R, 10BG and 108B, respectively, in accordance with the RGB image signals. Incidentally, for the sake of making a description easy, illustration of constructions of a manipulation system and other portions is omitted in FIG. 2.

Each of the LEDs 108R, 108G and 108B as light sources has a less exothermic quantity as compared with that of a high-output lamp such as a halogen lamp or a xenon lamp. Thus, miniaturization of the projector apparatus 10 by simplification of a heat radiation construction is realized.

The optical portion 100 has the projection lens 101 for projecting the image light, the LCDs 107R, 107G and 107B for displaying thereon the images corresponding to the RGB image signals, respectively, and the LEDs 108R, 108G and 108B for emitting the RGB lights, respectively. Also, prisms 102 to 104 constitute a dichroic prism for guiding the image lights from the respective LCDs 107R, 107G and 107B to the projection lens 101.

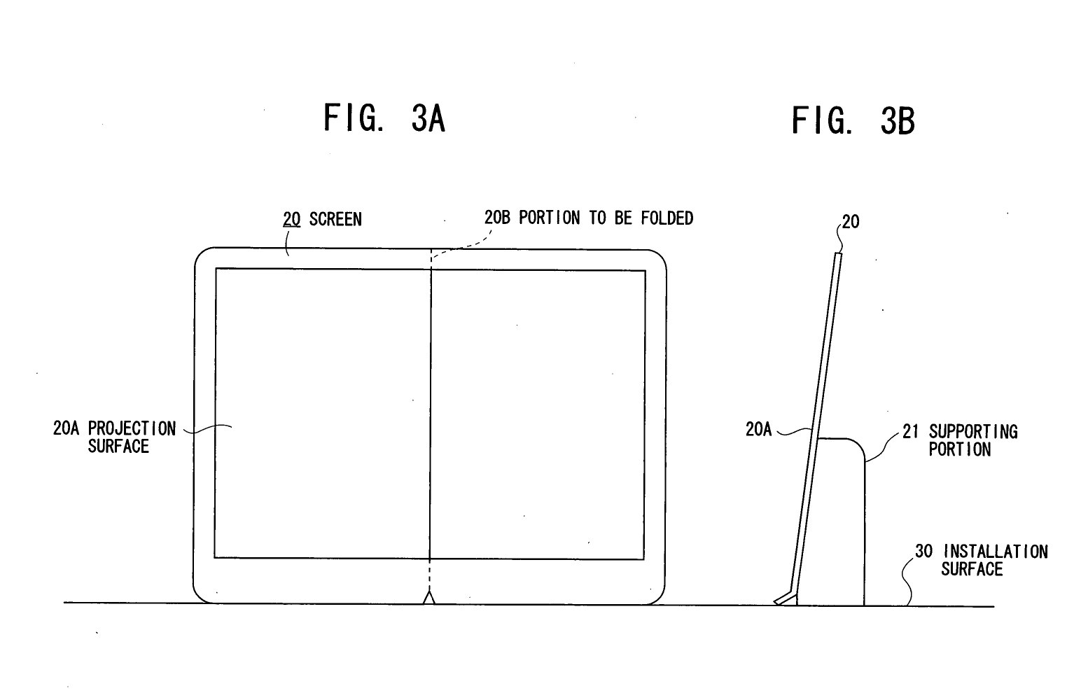

FIGS. 3A and 3B are respectively a front view of the screen 20 provided in the projection type image-displaying system 1 according to the first embodiment of the present invention, and a side elevational view of the screen 20 shown in FIG. 3A.

The screen 20 has a projection surface 20A having a screen gain in its front face. A portion 20B to be folded for making vertical half-folding possible is provided at a center of the screen 20. In addition, the screen 20 has a supporting portion 21 for placing the screen 20 in an inclined state on an installation surface 30 in its rear face. The supporting portion 21 can be housed so as to be flush with the rear face of the screen 20 in an accommodation phase. In this embodiment, the projection surface 20A of the screen 20 has a size of 458 mm×353 mm, and has a diagonal size of 576 mm. The screen 20 is designed such that when it is placed on the installation surface 30, its upper end is inclined in a rear face direction by 1.7 degrees.

In addition, the overall screen 20 is made of a resin material and is formed by applying a light diffusion material in uniform thickness to the projection surface 20A. Fine particles of a pearl or a white coating can be used as the light diffusion material.

[Use of Projection Type Image-Displaying System]

Hereinafter, a description will be given with respect to a use form for performing a simple presentation by using the projection type image-displaying system according to the first embodiment of the present invention.

Firstly, a conference table for a few persons is prepared, and the screen 20 is disposed in a position where the best visibility is obtained for seated participants. This screen 20, as described above, is disposed in a state in which its upper end is inclined in the rear face direction.

Next, the projector apparatus 10 is disposed at a predetermined distance (of 1 to 2 m) from the screen 20, and a power source is then turned ON to project the image light “L” on the projection surface 20A of the screen 20. At this time, when the image displayed on the projection surface 20A is defocused, the focusing for the image is performed by moving the position of the projector apparatus 10. After completion of the focusing for the image, the gamma adjustment and the adjustment for sharpness are performed as may be necessary, and the image light is regularly projected.

According to the first embodiment of the present invention described above, the projector apparatus 10 is used in which the optical portion 100 is offset so that the image projected on the projection surface 20A becomes suitable for the screen 20 provided in an inclined form. As a result, the image which is free from any of strains can be simply projected on the screen 20 which is simply provided on the desk or the like. In addition, since the projection surface 20A is constructed so as to have the screen gain, the satisfactory visibility can be obtained even with the projector apparatus having a smaller luminance than that of a large projector apparatus.

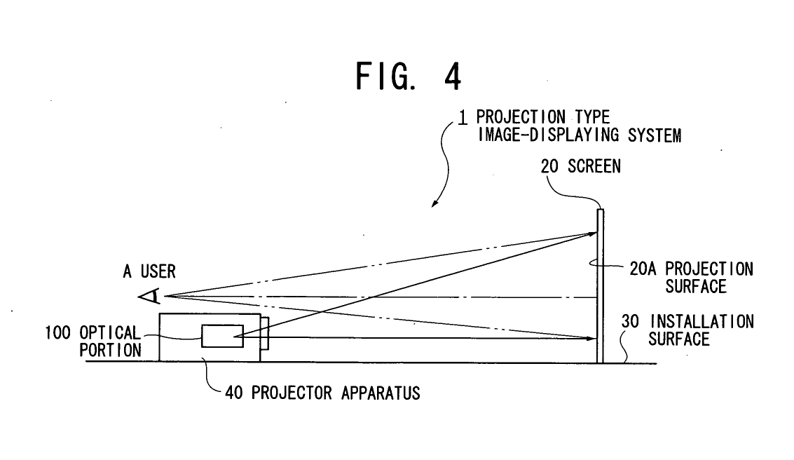

Use of such an inclined screen 20 is effective in ensuring the visibility when a projection type image-displaying system is constructed which is small in arrangement scale. For example, when the projector apparatus 40, as shown in FIG. 4, is placed on the installation surface 30, and the screen 20 is disposed at a right angle to the direction of the optical axis of the optical portion 100, there is such inconvenience that the projector apparatus 40 comes into a range of a visual field of the screen 20 which is desirable for the user A. In addition, there is also such inconvenience that when a distance between the screen 20 and the user A is short, the user A cannot visually recognize the image in the form of a proper shape since an inclination of a line of sight of the user A with respect to the screen 20 becomes large.

On the other hand, as shown in FIG. 1A, the image light “L” is projected on the screen 20 with the disposition of the inclined screen 20, whereby not only the posture of the screen 20 is stabilized, but also the line of sight in a state in which the user A naturally looks into the screen 20 enters nearly vertically the projection surface 20A of the screen 20. For this reason, not only no image strain occurs in the image visually recognized by the user A, but also the projector apparatus 10 comes to hardly enter the visual field of the user A.

Incidentally, the screen 20 which has been described in the first embodiment is of the vertical folding type in which the screen 20 can be folded at its center. However, the screen 20 may be of a horizontal folding type as long as it can be installed in a state of being inclined as described above. Moreover, there may also be adopted a screen of an assembly type in which a plurality of divided panels are coupled to one another to be assembled.

### Second Embodiment

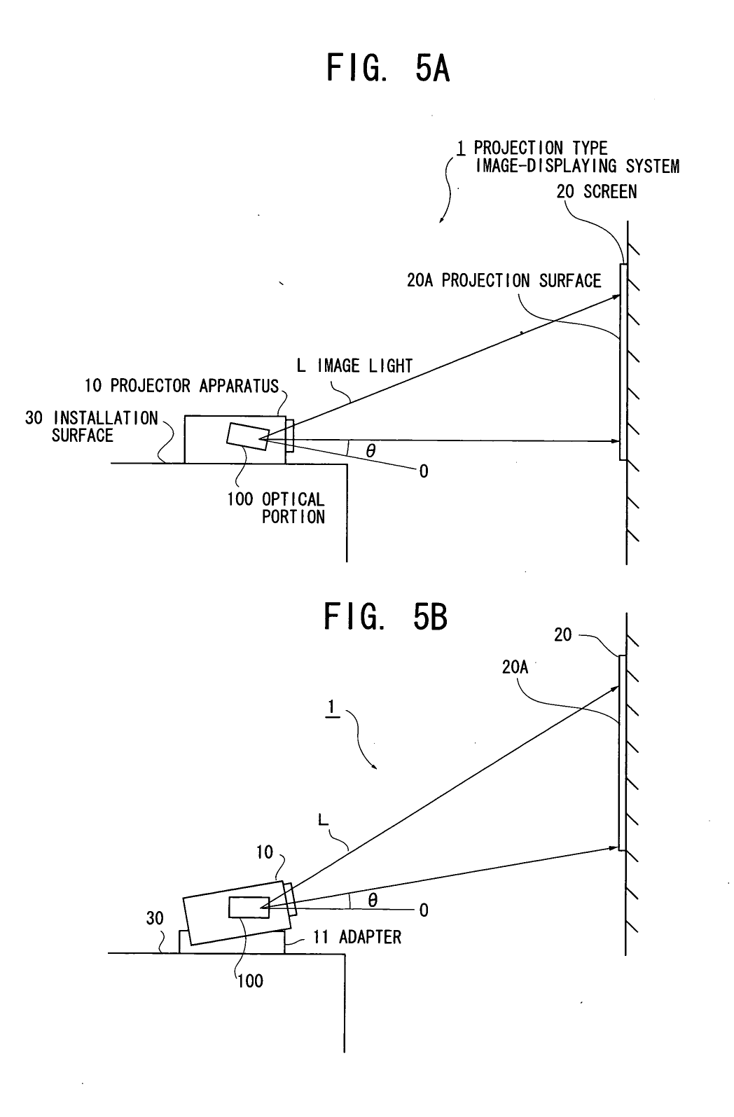

FIGS. 5A and 5B respectively a schematic constructional view of a projection type image-displaying system 1 according to a second embodiment of the present invention, and a schematic constructional view of the projection type image-displaying system 1, shown in FIG. 5A, using an adapter 11 for holding a posture of a projector apparatus 10 provided in the projection type image-displaying system 1. In the following description, portions having the same constructions and functions as those of the first embodiment are designated with the same reference numerals, respectively.

The projection type image-displaying system 1 is such that the screen 20 described in the first embodiment is fixed to a vertical wall surface, and the projector apparatus 10 is placed on the installation surface 30. Thus, a construction can also be adopted such that the image light “L” is emitted from the projector apparatus 10 described in the first embodiment to the screen 20 which is fixed to the vertical wall surface.

In addition, as shown in FIG. 5B, the adapter 11 for setting the posture of the projector apparatus 10 may be used. In this case, the projector apparatus 10 may be set with its posture and placed on the installation surface 30 through the adapter 11 so that the image light “L” can be projected in accordance with the disposition of the projector apparatus 10 and the screen 20 which has been described in the first embodiment.

According to the second embodiment of the present invention described above, not only the image light “L” can be projected on the screen other than the inclined screen 20 as described in the first embodiment, but also the image light “L” can be suitably projected on the dis-inclined screen by using the adapter 11.

### Third Embodiment

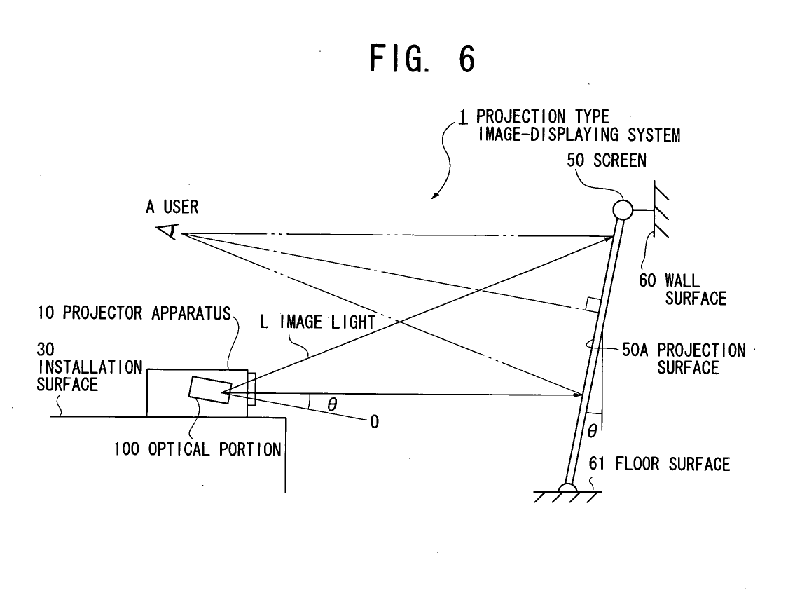

FIG. 6 is a schematic constructional view of a projection type image-displaying system 1 according to a third embodiment of the present invention.

This projection type image-displaying system 1 is such that the image light “L” emitted from the projector apparatus 10 described in the first embodiment is projected on a suspended screen 50. The suspended screen 50 is supported and fixed to a wall surface 60, and a lower portion of the suspended screen 50 is supported by a floor surface 61, whereby the projection type image-displaying system 1 is installed such that a projection surface 50A makes an angle 0 of inclination with respect to the wall surface 60 similarly to the first embodiment.

According to the third embodiment of the present invention described above, the same effect as the desirable effect of the first embodiment can be obtained even with the suspended screen 50 as well.

### Fourth Embodiment

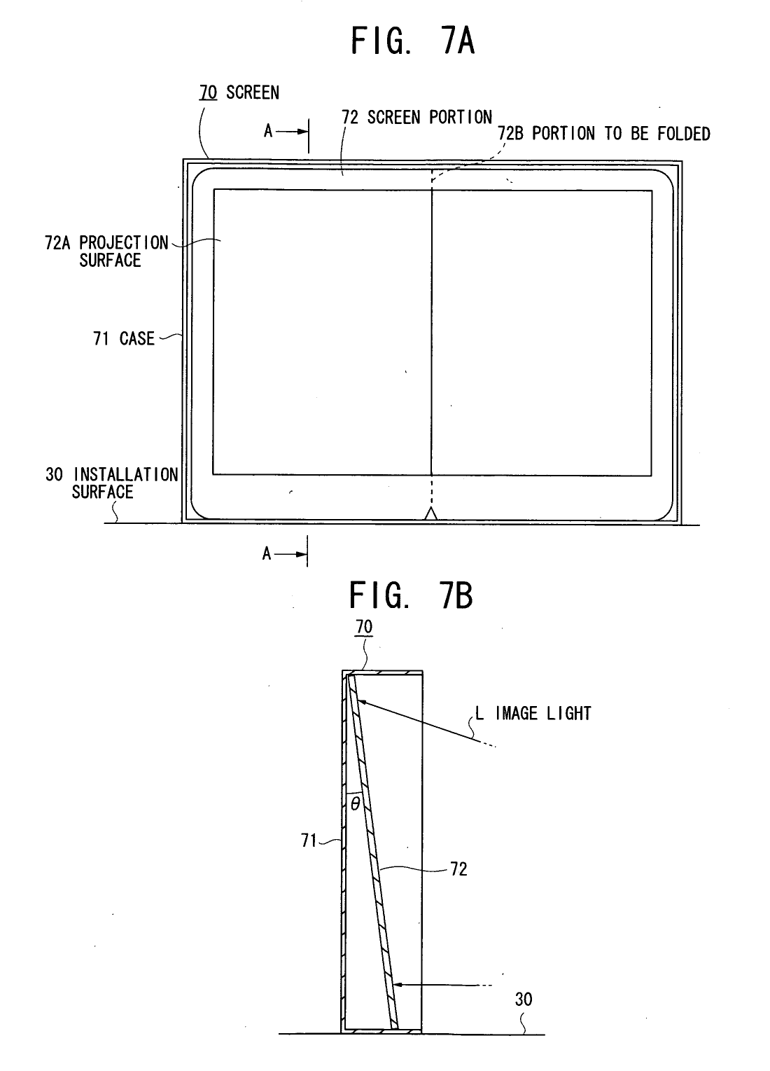

FIGS. 7A and 7B are respectively a front view showing another construction of a screen provided in a projection type image-displaying system according to a fourth embodiment of the present invention, and a cross sectional view taken on a line A-A of FIG. 7A.

The screen 70 of the fourth embodiment has a case 71 serving both an accommodating body and a screen-supporting portion, and a screen portion 72 having a projection surface 72A. The screen portion 72 is formed so as to make the angle θ of inclination described in the first embodiment with respect to a rear face of the case 71. Also, the screen portion 72 has a folding construction in which the vertical half-folding can be made at a portion 72B to be folded similarly to the screen 20 described in the first embodiment.

The case 71 constitutes, together with a cover portion (not shown), the box-like accommodating body. Thus, when the projector apparatus 10 is unused, the vertically half-folded screen portion 72 and the projector apparatus 10 which are packed together can be accommodated in the case 71.

According to the fourth embodiment of the present invention described above, in addition to the desirable effect of the first embodiment, the following effects can be obtained. That is to say, the screen portion 72 can be installed in the state of being inclined by a suitable angle corresponding to the image light “L” emitted from the projector apparatus 10 by only placing the case 71 on the installation surface 30 of a desk or the like. In addition, since the projector apparatus 10 and the screen portion 72 can be together accommodated in the same box-like accommodating body, their arrangement and accommodation are readily performed, and the efficient operation for the projector can be made.

It should be noted that the present invention is not intended to be limited to the first to fourth embodiments described above, and the various changes thereof can be made without departing from or changing the technical idea of the invention.

What is claimed is:

1. A projection type image-displaying apparatus, comprising:
a main body installed on an installation surface; and
an optical portion, having an optical axis, for projecting an image light on an inclined projection surface, the optical portion being accommodated in the main body for the optical axis to be disposed relative to the installation surface by a predetermined angle determined in accordance with an inclination angle of the inclined projection surface.

2. A projection type image-displaying apparatus according to claim 1, wherein:
the optical portion projects the image light generated in accordance with a light emitted from a light source constituted by a light-emitting diode (LED) on the projection surface.

3. A projection type image-displaying apparatus according to claim 1, wherein:
the optical portion projects the image light generated in accordance with a light emitted from a light source constituted by a liquid crystal display (LCD) on the projection surface.

4. A projection type image-displaying apparatus according to claim 1, wherein:
the predetermined angle for the optical axis of the optical portion is equal to the inclination angle of the inclined projection surface, the inclination angle being an angle relative to a surface normal to the installation surface, thereby marking the optical axis of the optical portion to be parallel with a direction normal to the inclined projection surface.

5. A projection type image-displaying apparatus according to claim 1, wherein:
the inclined projection surface is provided in a state of being backward inclined in accordance with installation so that a lower end of the image light becomes parallel with an installation surface.

6. A projection type image-displaying apparatus according to claim 1, wherein:
the optical portion comprises prisms for combining red, green and blue image lights.

7. A projection type image-displaying system, comprising:
a projection type image-displaying apparatus comprising an optical portion, having an optical axis, for projecting an image light on an inclined projection surface, the optical axis being disposed so as to be parallel with a direction of a normal to the inclined projection surface; and
a screen installed in a state in which the projection surface is inclined, the image light being projected on the inclined projection surface.

8. A projection type image-displaying system according to claim 7, wherein:
the screen has a foldable desk-top installation type form.

9. A projection type image-displaying system according to claim 7, wherein:
the screen has a screen gain in a direction of a normal to the projection surface.

10. A projection type image-displaying system according to claim 7, wherein:
the optical portion is accommodated in a main body.

11. A projection type image-displaying system according to claim 7, wherein:
the inclined projection surface is provided in a state of being backward inclined in accordance with installation so that a lower end of the image light becomes parallel with an installation surface.

12. A projection type image-displaying system according to claim 7, wherein:
a projection type image-displaying apparatus comprises:
a projection lens, having the optical axis which is disposed so as to make an angle with respect to a direction of a normal to the projection surface, for projecting an image light; and
a screen for receiving the image light to produce an image thereon, the screen being inclined with an angle in accordance with the angle with which the optical axis is disposed.

13. A projection type image-displaying system according to claim 7, wherein:
the projection surface of the screen is approximately normal to a central line of a viewpoint of a user.

14. A projection type image-displaying system, comprising:
an optical portion for projecting an image light, the optical portion being accommodated in a main body, and at least one of the optical portion and the main body being inclined with respect to a reference plane by a predetermined angle; and
a screen for receiving the image light to produce an image thereon, the screen being inclined with respect to the reference plane by an angle determined in accordance with the predetermined angle.

15. A projection type image-displaying system according to claim 14, wherein:
the optical portion comprises prisms for combining red, green and blue image lights to generate the image light which is projected therefrom to the screen.

16. A projection type image-displaying system according to claim 14, wherein:
the optical portion comprises a projection lens for projecting the image light, the projecting lens being inclined with respect to the reference plane by the predetermined angle.

17. A projection type image-displaying system according to claim 14, wherein:
the projection surface of the screen is approximately normal to a central line of a viewpoint of a user.

18. A projection type image-displaying system according to claim 14, wherein:
the optical portion projects the image light generated in accordance with a light emitted from a light source constituted by a light-emitting diode (LED) on the projection surface.

19. A projection type image-displaying system according to claim 14, wherein:
the optical portion projects the image light generated in accordance with a light emitted from a light source constituted by a liquid crystal display (LCD) on the projection surface.

20. A projection type image-displaying system according to claim 14, wherein:
the inclined projection surface is provided in a state of being backward inclined in accordance with installation so that a lower end of the image light becomes parallel with an installation surface.
